(19) United States
(12) Patent Application Publication
(10) Pub. No.: US 2009/0274996 A1
(43) Pub. Date: Nov. 5, 2009

(54) BONE CUTTING DEVICE AND METHOD OF USING SAME

(76) Inventor: Kenneth Miller, Dalton, PA (US)

Correspondence Address: FOX ROTHSCHILD LLP, 2000 MARKET STREET, 10th Floor, PHILADELPHIA, PA, 19103, US

(21) Appl. No.: 12/115,274

(22) Filed: May 5, 2008

(51) Int. Cl. A61C 3/02; A61C 1/00

(52) U.S. Cl. 433/215; 433/165

(57) ABSTRACT

A bone cutting device having a cylindrical body that has cutting teeth on one end, a shaft extending from another end of the body for attachment to a drill, which shaft can provide cooling water to the body, and a drill extending beyond the cutting teeth for contacting the bone prior to the cutting teeth contacting the bone.

### FIELD OF THE INVENTION

The present invention relates generally to drilling and cutting devices, and more particularly to devices for making precisely-placed openings in bone, such as for preparation of dental implant sites.

### BACKGROUND OF THE INVENTION

There are various methods for preparing dental implant sites. These are typically cylindrical openings formed in the patient's bone, such as in the alveolar bone of the maxilla, which can receive the implant via procedures well known in the art.

For patients with an alveolar bone thickness of more than about 5 millimeters, a dental implant can be secured in a relatively stable manner using the existing bone. Here an implant drill can be used to create the implant site in a known manner.

For patients with less than about 5 millimeters alveolar bone thickness, however, dental surgeons can use various procedures to build up the thickness of the alveolar bone so that the dental implant may be installed securely therein. This can be a particular problem in the area beneath the sinus cavity. One method of building up bone beneath the sinus cavity is to perform a sinus lift procedure where the surgeon opens a hole in the side wall bone of the maxillary sinus cavity. The sinus cavity membrane is then separated from the upper surface of the maxilla, and a material mixture, preferably including the patients own bone harvested from a donor site, is inserted at the bottom of the sinus cavity between the maxilla and the sinus lining. This living bone mixture grows over time to increase the effective thickness of the maxilla, thereby providing additional stability for the implant. This method requires bone to be harvested from a donor site, such as by use of a trephine drill, and has various risks associated with it related to the breaking of the bone in the side wall of the sinus cavity.

Another method of increasing the alveolar bone thickness in the area beneath the sinus is to push bone material from the implant site up into the area between the maxilla and the sinus lining. Here, an incision is made into the gum at the approximate site where the implant opening will be made. Then, an osteotome is hammered into the bone at the implant site to push the bone upward and create the implant opening. This procedure begins with a small diameter osteotome, followed by ever larger ones, until the desired diameter is reached. It is appreciated that this process breaks away and pushes the bone from the implant site up into the area of the bottom of the sinus cavity between the maxilla and the sinus lining. As with the sinus lift method discussed above, the bone pushed up into the area between the maxilla and the sinus lining hardens over time to increase the effective thickness of the maxilla, thereby providing additional stability for the implant.

One problem associated with any procedure using an osteotome is the accurate placement of the osteotome against the bone for creating the initial opening. The surface of the bone can be oriented and shaped such that the precise positioning of the initial opening using the osteotome is difficult. For example, the osteotome may be angled relative to the bone surface, making it difficult to keep the osteotome in the desired position during the initial hammering. Accordingly, it is believed that a more precise means for initiating the opening in such procedures would be advantageous. Moreover, any procedure where bone is to be removed or drilled can be improved with a more precise means for initiating the opening.

### SUMMARY OF THE INVENTION

The present invention provides a device and method for initiating an opening in bone. In one form, the invention provides a device having a cylindrical body that defines a hollow space within it. The body has a distal end that has cutting teeth, and a proximal end opposite the distal end. A shaft extends coaxially from the proximal end of the body, which shaft has one end attached to the body and a second end configured to be attached to a drill, such as a dental drill, and which shaft includes a water opening for communicating with a water supply to receive water therefrom. The shaft further forms a conduit within it for receiving water from the water opening and delivering the water to the cylindrical body for cooling purposes during use. A drill bit extends coaxially within the hollow cylindrical body and has a drill bit tip extending distally beyond the cutting teeth for contacting the surface of a bone before the cutting teeth contact the bone. The drill bit can include an opening in a drill bit shaft through which cooling water from said conduit can exit.

A novel method of making an opening for an implant while lifting bone up into the area between the maxillary and sinus membrane is also provided.

### BRIEF DESCRIPTION OF THE DRAWINGS

The following detailed description will be better understood when read in conjunction with the figures appended hereto. For the purpose of illustrating the invention, there is shown in the drawings a presently preferred embodiment. It is understood, however, that this invention is not limited to this embodiment shown. It should be noted that the figures are not necessarily drawn to scale.

The present invention will now be described by way of example with reference to the following drawings in which:

FIG. 1 is a perspective view of an exemplary device in accordance with the present invention;

FIG. 2 is a cross-sectional view of the device of FIG. 1, taken along line 2-2 of FIG. 1;

FIG. 3 is a cross-sectional view of the device of FIG. 1, taken along line 3-3 of FIG. 2;

FIGS. 4 and 5 are cross-sectional views of an alveolar bone and a maxillary sinus cavity, showing exemplary use of the device for drilling into bone;

FIG. 6 is a cross-sectional view of an alveolar bone and a maxillary sinus cavity, showing a bore made by the device of FIG. 1;

FIG. 7 is a cross-sectional view of the alveolar bone and sinus cavity of FIG. 6, showing an osteotome in use to displace bone tissue; and

FIG. 8 is a cross-sectional view of the alveolar bone and sinus cavity of FIG. 7, showing placement of a dental implant.

### DETAILED DESCRIPTION

FIGS. 1-3 show an exemplary device 10 in accordance with the present invention configured for use with dental implant procedures. As shown in FIGS. 1-3, the exemplary device 10 resembles in part a conventional trephine in that it includes a tubular body 12, such as a thin cylinder of surgical grade stainless steel, fixedly supported at one end on a shaft 14 configured for receipt in a chuck of a surgical drill, such standard connection means to a surgical drill being well known in the art. Such surgical drills are known in the art, such as those used with conventional trephines. An opposite end of the body 12 supports a plurality of cutting teeth 16 arranged about the body's edge 18 as shown. The body 12 may include circumferentially-extending grooves or other depth-of-cut markings 24 (FIG. 1) at regular longitudinally spaced intervals to indicate cut depths. Openings 20 may be provided in the body 12 to promote cooling resulting from use of the device 10. Any suitable configuration of openings 20 may be used. For example, multiple smaller openings may be used in place of each of the larger openings.

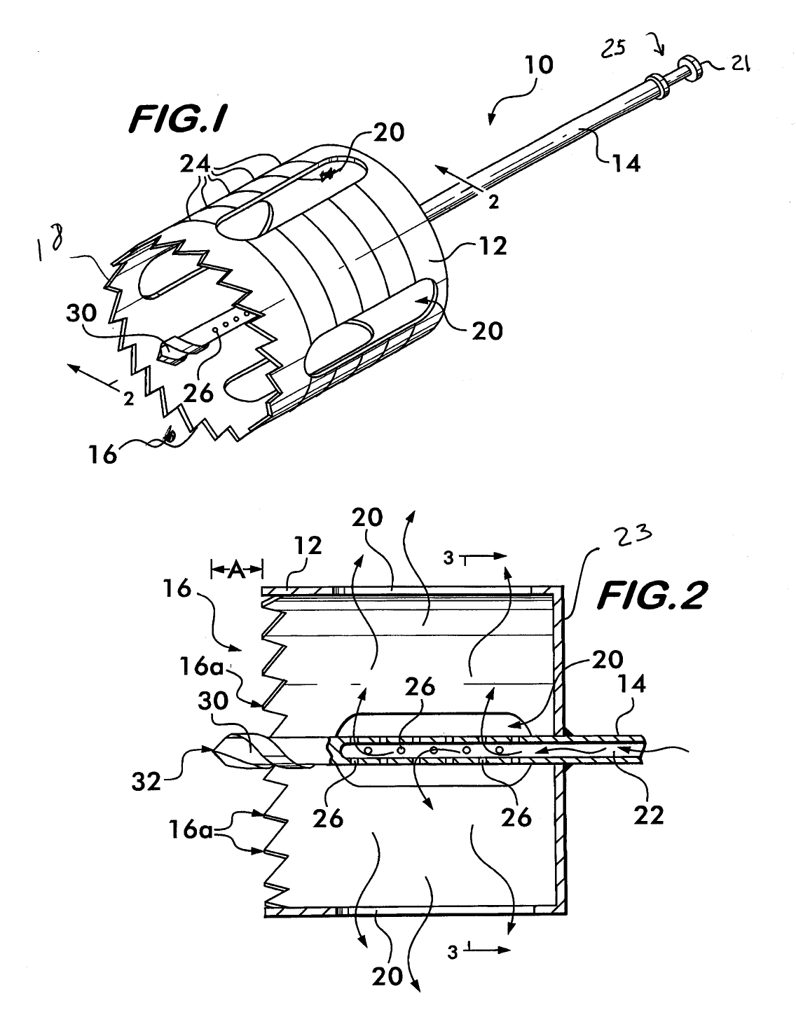

The shaft 14 may include an opening 21 at its end and a longitudinally extending conduit or passage 22 (FIG. 2) connected to said opening 21 and formed within the shaft for delivering a flow of water to an internal or external portion of the body 12. This promotes cooling of surrounding bone to prevent damage to the bone from the heat generated during the cutting process. The flow of water may be supplied to the opening 21 by drill equipment as known in the art.

A circular cap member 23 encloses the proximal end of the body 12 and provides a means for attaching the shaft 14 to said body 12 via any suitable means.

By way of example, a device 10 adapted for dental surgery may have a body having an outside diameter measuring approximately 3 mm to approximately 8 mm, a body wall thickness of approximately 0.5 mm, and a length measuring approximately 5 mm to approximately 25 mm, and preferably approximately 10 mm. The overall length may be approximately 15 mm or less.

In accordance with the present invention, the exemplary device 10 includes a drill bit 30, such as a fluted drill bit, extending co-axially within the hollow section of the body 12. The drill bit 30 has a distal tip 32 that is positioned to protrude beyond distal tips 16a of the body's teeth 16, as best shown in FIG. 2. The drill bit and its tip can be configured in any suitable manner as is known in the oral surgery and dental field. Preferably, the drill bit 30 is positioned relative to the body 12 such that the distal tip 32 extends beyond the body's teeth 16 by a relatively small amount that is sufficient to permit the drill bit 30 to create a pilot hole in the bone, or to follow a pre-made pilot hole, and thus to guide drilling by the device 10, before the body's teeth 16 contacts the bone. Protrusion of the drill bit's distal tip 32 beyond the distal tips 16a of the teeth 16, as shown at A in FIG. 2, of approximately 0.5 mm to approximately 3 mm, and preferably about 1.5 mm is believed suitable for this purpose. The drill bit 30 may have an outer diameter of approximately 1 mm, to prevent excessive loss of bone. Additionally, such minimal protrusion avoids excessive loss of bone, and thus retains substantially all of the original bone tissue within the annular cut made by the teeth 16 of the device 10.

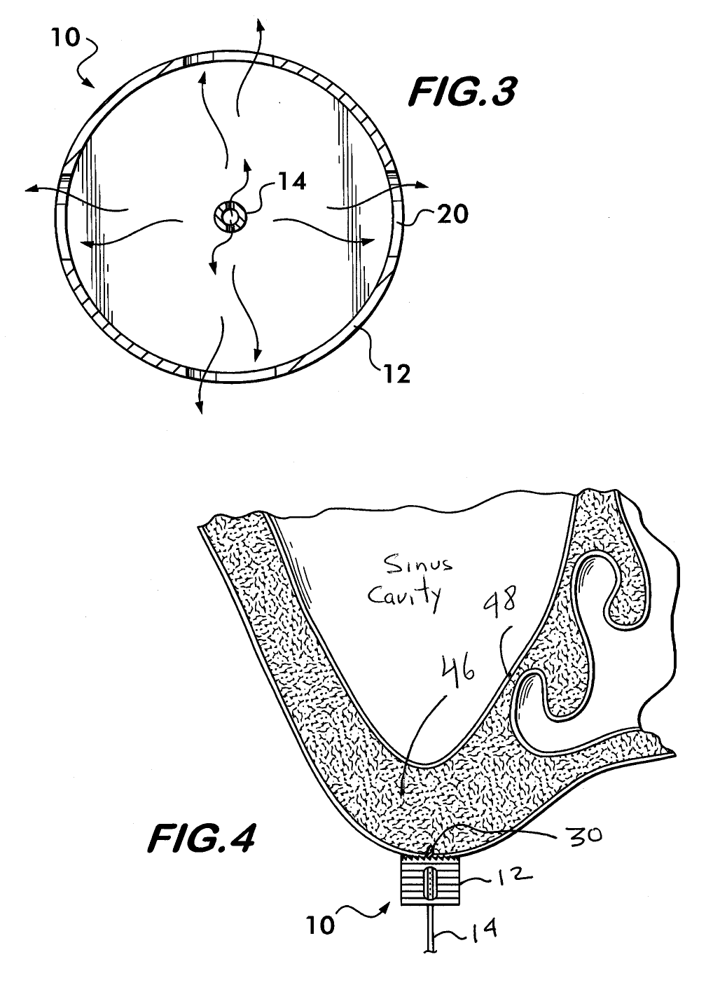

The drill bit 30 can be attached to or formed as part of the shaft 14, extending through the center of the cap 23 as illustrated. In this manner the water passage 22 extends into the drill bit 30 so that the water can be delivered through one or more openings 26 formed in the shaft of the drill bit into the hollow space within the body 12. This allows cooling water to be delivered to the area of bone that is being cut as indicated by the arrowed lines illustrating the flow of water from the openings 26 in FIGS. 2 and 3.

The device 10 can be made of any suitable materials, such as medical grade stainless steel.

In use, the device 10 may be mounted in a conventional surgical drill, which may be configured in a conventional manner to provide a flow of cooling water to the shaft opening. The drill may be operated in a conventional manner. The present device 10 may be used to precisely-place a cut in bone by positioning the distal tip 32 at a center of an annular cut that is desired to be made (see FIG. 4 illustrating placement of the device 10 on the alveolar bone of the maxillary 46 at the site where an implant opening will be made). The small diameter of the drill bit 30 relative to the device body 12, and the configuration of the bit, facilitates drilling of a hole in bone at the exact location desired. Unlike drilling with a conventional drill device, drilling with such a bit is not prone to “walking” that results in drilling in a location that does not have a flat surface perpendicular to the desired drill path.

Optionally, a pilot hole in the desired location may be drilled with a separate pilot drill bit, and then the device 10 may be used by first positioning the distal tip 32 of the drill bit 30 in the pre-made pilot hole. This further facilitates drilling of bone in the precise location desired.

After the bit 30 has made an initial hole in the bone or is placed within a pre-made pilot hole, drilling continues in a similar manner, and the teeth 16 of the device 10 begin to cut the bone in the desired location. “Walking” of the device 10 during this phase of drilling is prevented by constraint of the drill bit 30 by bone surrounding the pilot hole made in the bone. This facilitates drilling of bone in the precise location desired. See FIGS. 4-6.

Cutting may continue until the desired depth of annular cut has been made by the teeth 16, as may be indicated by the depth-of-cut markings on the body 12 of the device 10. See FIG. 5. During drilling, irrigation water flows through the passage 22 in the shaft, exiting through openings 26 in the shaft (FIG. 2) into the interior of the hollow body 12, and exiting the body 12 via windows 20, as best shown in FIGS. 2 and 5.

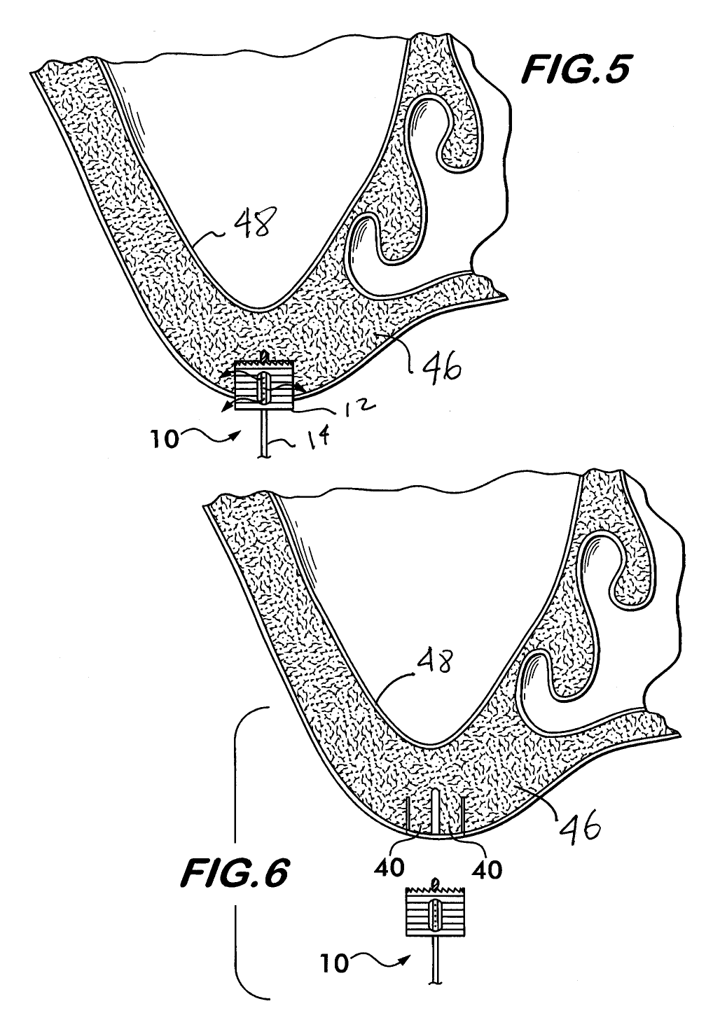

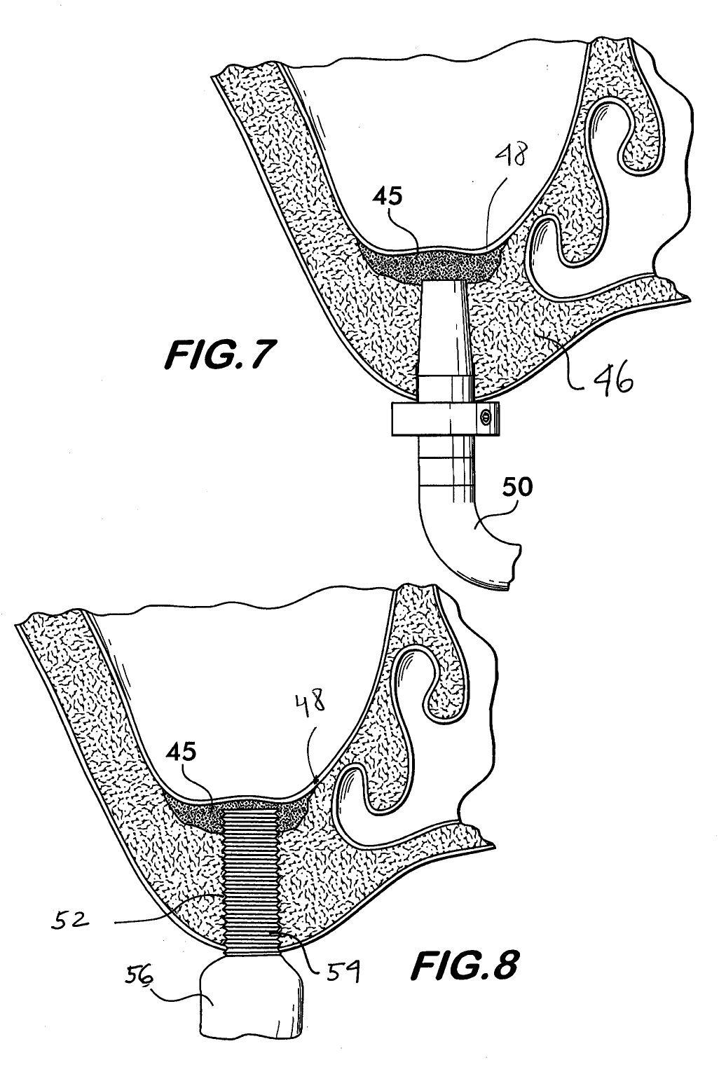

It will be noted that there is minimal loss of bone beyond the depth of the annual cut due to the limited protrusion of the bit 30 beyond the distal tips 16a of teeth 16 of the device 10, as best shown in FIG. 6. It will be further noted that there is minimal loss of bone from within a boundary 40 defined by the annular cut of the device, due to the small diameter of the drill bit 30. Substantially all of the bone tissue within the boundary of the annular cut remains intact, as best shown in FIG. 6 which illustrates the cut made by the device 10 after the device is removed. Accordingly, the desired cut may be made, in a precise manner, without excessive loss of bone.

The bone remaining within the boundary of the annular cut made by the device 10 may be used in a bone lift procedure. For example, the remaining bone 40 within the annular cut can be displaced upwardly with an osteotome 50 to create a region 45 of thickened bone tissue below the sinus membrane 48. As in a normal sinus lift procedure, a series of osteotomes of increasing sizes up to the desired opening size may be used to displace the tissue within the annular cut by hammering the osteotome(s) into the area within the annular cut. It is seen that the annular cut defines a boundary of the hole thus created, and allows for precise positioning of the implant opening. The displaced bone creates the region 45 of thickened bone tissue providing a strong point for anchoring a dental or other implant.

Thus the present device provides a novel method for providing a sinus lift. An incision is made into the gum at the approximate site where the implant opening will be made. Next, a small pilot hole is drilled at the exact site for the implant. Then, using the device 10, with the drill bit 30 using the pilot hole as a guide, the outer diameter of the opening for the implant is cut to create a detached section of bone 40 as illustrated in FIG. 6. An osteotome is then used to hammer the cut bone upward the desired depth to create the implant opening, while at the same time pushing the bone upward to create an area of additional bone 45 for thickening the bone above the implant site. This provides a more accurate placement of the implant hole 52 since the initial small diameter pilot drill can more easily be placed exactly where desired, allowing the osteotome 50 to act on the exact area of bone desired for the implant opening. An implant 54, in the implant opening 52, and prosthesis 56 are shown in FIG. 8.

Although the invention has been described in language specific to the structural features shown, it is to be understood that the invention defined in the appended claims is not necessarily limited to the specific features or acts described. Rather, the specific features and acts disclosed are of a presently preferred embodiment and thus an exemplary form of implementing the claimed invention. For example, it is believed that the device 10 can be used for procedures other than those described above, such as for use in obtaining bone tissue for use in bone grafting, or any other procedure involving bone where precise drilling and cuts are required.

What is claimed is:

1. A device for initiating an opening in bone, said device comprising:
a cylindrical body defining a hollow space within it, said body having a distal end defining and edge having cutting teeth, and a proximal end opposite said distal end;
a shaft extending coaxially from said proximal end of said body, said shaft having one end attached to said body and a second end configured to be attached to a drill and which includes a water opening for communicating with a water supply, said shaft forming a conduit within for receiving water from said water opening and delivering the water to area of bone to be opened; and
a drill bit extending coaxially within said hollow cylindrical body and having a drill bit tip extending distally beyond said cutting teeth for contacting the surface of a bone before said cutting teeth.

2. The device of claim 1 wherein said drill bit is connected to and extends from said shaft.

3. The device of claim 2 wherein said drill bit includes a water conduit formed within it for receiving water from said shaft, said drill bit having an opening formed along a shaft of said drill bit through which water can exit from said drill bit.

4. A method a thickening a bone for use with a dental implant in the alveolar bone of the maxilla, comprising:
(a) making an incision into the gum at the approximate site where the implant opening will be made;
(b) making a small pilot hole at the exact site for the implant;
(c) cutting bone at the site for the implant using a device in accordance with claim 1, wherein said drill bit tip is placed into said pilot hole for this cutting step;
(d) providing cooling water to the bone being cut via said conduit in said shaft; and
(e) hammering the cut bone upward the desired depth to create the implant opening, while at the same time pushing the bone upward to thicken the bone above the implant site.

5. The method of claim 4 wherein said pilot hole is made using a pilot drill.

6. The method of claim 4 wherein step (e) comprises the use of an osteotome which is hammered against the cut bone to move said bone upward.

7. The method of claim 6 wherein step (e) comprises the use of a plurality of osteotomes used in order of increasing diameters.

8. A method a thickening a bone for use with a dental implant in the alveolar bone of the maxilla, comprising:
(a) making an incision into the gum at the approximate site where the implant opening will be made;
(b) cutting bone at the site for the implant using a device in accordance with claim 1;
(c) providing cooling water to the bone being cut via said conduit in said shaft; and
(d) hammering the cut bone upward the desired depth to create the implant opening, while at the same time pushing the bone upward to thicken the bone above the implant site.

9. The method of claim 8 wherein step (d) comprises the use of an osteotome which is hammered against the cut bone to move said bone upward.

10. The method of claim 9 wherein step (d) comprises the use of a plurality of osteotomes used in order of increasing diameters.

11. The device of claim 2 wherein said drill bit includes a water conduit formed within it for receiving water from said shaft, said drill bit having at least one opening therein through which water from said conduit can exit said drill bit.

12. The device of claim 3 wherein said opening is located near said drill tip.

13. The device of claim 3 wherein said opening is located near a mid section of said drill bit.

14. The device of claim 2 wherein said drill bit and said shaft are formed from a unitary member.

15. The device of claim 1 wherein said cylindrical body has at least one opening therein.
